(19) United States
(12) Patent Application Publication
(10) Pub. No.: US 2026/0309744 A1
(43) Pub. Date: Oct. 8, 2026

(54) METHOD OF AND SYSTEM FOR PROCESSING THREEDIMENSIONAL MEASUREMENT DATA FROM A SCANNING PROBE MICROSCOPY SYSTEM, AS WELL AS COMPUTER PROGRAM PRODUCT

(71) Applicant: Nearfield Instruments B.V., Rotterdam (NL)

(72) Inventors: Hamed SADEGHIAN MARNANI, Rotterdam (NL); Cornel BOZDOG, Boise, ID (US); Robert Joel TRUSSELL, Boise, ID (US)

(21) Appl. No.: 19/480,948

(22) PCT Filed: May 3, 2024
(86) PCT No.: PCT/NL2024/050227

§ 371 Date: Nov. 3, 2025

(30) Foreign Application Priority Data
May 4, 2023 (NL) 2034762

(51) Int. Cl. G01Q 30/04; G01B 15/08

(52) U.S. Cl. CPC G01Q 30/04; G01B 15/08

(57) ABSTRACT

The invention is directed at a method of processing three-dimensional measurement data from a scanning probe microscopy system for providing three-dimensional topography image data, as well as a method of performing scanning probe microscopy, a scanning probe microscopy system, a computer-implemented method and a computer program product. The method comprises receiving, by a processing device, 3D measurement data obtained by the SPM system, which typically maps a topography of structures comprised by the substrate. The method further includes a step of digitally constructing a model image data using shape contour data of shapes, and a regression operation for fitting the model image data to the 3D measurement data. This yields a synthetic model image of the 3D measurement data, useable as topography image.

### FIELD OF THE INVENTION

The present invention is directed at a method of processing three-dimensional measurement data from a scanning probe microscopy system for providing three-dimensional topography image data, as well as a method of performing scanning probe microscopy, a scanning probe microscopy system, a computer-implemented method and a computer program product.

### BACKGROUND

Scanning probe microscopy (SPM) forms a family of techniques that utilize a range of interactions between a probe tip and a surface to image on-surface and/or sub-surface topography with nanometer level resolution and accuracy. SPM tools are for example applied to provide 3D images of semiconductor devices on wafers, in-between processing steps, to enable process control and yield management of high-volume manufacturing (HVM) of semiconductor logic and memory chips. For these applications, achieving a high throughput at a satisfactory level of accuracy is key in order for the technology to be useable for this purpose. In general, achieving high throughput allows SPM technology to be of added value in many more applications, areas of technology and industrial processes.

The raw output of a scanning probe microscopy system typically includes three-dimensional (3D) measurement data. This could be on-surface data relating to the topography of structures at the surface of a sample, or sub-surface three-dimensional measurement data relating to the topography of structures and patterns below the surface. For example, sub-surface measurements enable the verification of overlay and alignment in semiconductor elements during and after fabrication, enabling the manufacturing process to yield a satisfactory percentage of correctly fabricated and working semiconductor devices, and minimizing loss. One of the present bottlenecks in an SPM imaging process in terms of achieving a high throughput, is the processing of the raw 3D measurement data prior to providing a topographic image. The data processing involves many individual steps ranging from noise reduction and the identification and removal of artefacts to preparing the results for a subsequent step wherein the results are used (e.g. for metrology purposes). Therefore, there is a need for further improvement of the process in order to gain efficiency in terms of data processing.

### SUMMARY OF THE INVENTION

Some aspects of the present disclosure relate to methods of processing three-dimensional measurement data from a scanning probe microscopy system for providing three-dimensional topography image data. Other or further aspects relate to scanning probe microscopy systems therefore, and yet other or further aspects relate to computer-implemented methods and computer program products for processing three-dimensional measurement data from a scanning probe microscopy system.

Typically, a scanning probe microscopy system comprises a substrate carrier for supporting a substrate (sometimes also referred to as sample). The system may also comprise a probe including a cantilever and a probe tip for scanning a surface of the substrate. By scanning the substrate surface in this manner, the system in use obtains three-dimensional measurement data. For example, in some embodiments the exact position in three orthogonal dimensions of a coordinate system (e.g. X, Y, and Z in cartesian coordinates; r, θ and φ in spherical coordinates; or r, θ and z in cylindrical coordinates) of the probe tip may be registered when it is in contact with (or makes contact with) the substrate surface. In other or further embodiments, an acoustic signal is applied to one or more of the probe tip and the substrate, and three-dimensional measurement data may be obtained by registering a phase and/or amplitude of a return signal, being indicative of subsurface topography. The obtaining of three-dimensional measurement data by scanning the surface of the substrate with the probe tip may be performed in various different manners, and the invention is not limited to a specific mode of measurement in this respect.

Typically, the method of processing three-dimensional measurement data as described herein comprises receiving, by a processing device, the three-dimensional measurement data which has been obtained by the scanning probe microscopy system by said scanning of the surface of the substrate. This three-dimensional measurement data typically maps a topography of one or more structures comprised by the substrate. In a very common form, this may comprise the sensed 3D coordinates of the exact position of the probe tip when in contact with the surface, but as explained other forms of 3D topography data may be received in this step. The method further includes a step of digitally constructing, by the processing device, a model image data using shape contour data of one or more shapes. Here, the model image data is constructed by at least one of arranging or sizing of the contour data, in order to match the three-dimensional measurement data for mimicking the topography of the one or more structures comprised by the substrate. The matching does not need to be exact yet at this stage, although one may appreciate that a better matching of the model image data with the three-dimensional measurement data may ease up subsequent steps in the process. Thereafter, a regression operation is iteratively performed by the processing device for fitting the model image data to the three-dimensional measurement data. This yields, when fitted, a synthetic model image of the three-dimensional topography of the substrate from the fitted model image data. According to the present method, the synthetic model image is provided as three-dimensional topography image data of the topography of the substrate as an output (e.g. via an output). This, for example in accordance with some embodiments, enables to perform metrology measurements on the topography of the one or more structures.

In accordance with the present invention, the three-dimensional measurement data is modelled with an equivalent, synthetic image with floating parameters. For example, in some embodiments, the step of digitally constructing is performed by reconstructing the received three-dimensional measurement data from building blocks. This building blocks are provided by shapes, e.g. standard three-dimensional shapes, digitally defined by their contour data. The shapes, or parts thereof, are used in order to reconstruct the three-dimensional measurement data as accurate as possible. This could include, in some further or other embodiments, a convenient combining, uniting or subtraction of shapes such as to reconstruct more complex three-dimensional shapes. Also, in some embodiments, the shapes are only partly used, for example by a suitable truncation. In principle, various kinds of operations may be applied on the shapes during the digital construction step. For example, in some embodiments the arranging or sizing of the contour data comprises at least one of: translating, rotating, inflating, deflating, flattening, stretching, compacting, truncating or resizing of the contour data of the one or more shapes; or the combining, merging, uniting or subtracting of contour data of at least two of the shapes.

Thereafter, the iterative process of regression enables to fit the model image data to the three-dimensional measurement data, such as to yield a synthetic model image of the three-dimensional topography of the substrate. The main advantage is that this method can be performed much more efficient than the convention way of data processing. Furthermore, it yields a data log of operations from which it becomes evident what parts of the image relate to artefacts and what parts actually relate to the topography of the substrate structures. For example, in other or further embodiments, the method further comprises a step of adapting the model image data such as to include therein measurement artefact data, wherein the measurement artefact data is indicative of image modifications caused by the obtaining of the three-dimensional measurement data by the scanning probe microscopy system. For example, some of these measurement artefacts may be included in a relatively straightforward manner, such as noise, spikes, tilts, background slopes or tip-sample interaction artifacts.

Regarding the latter, if the shape of the probe tip (or a good estimate thereof) as well as the direction of motion of the probe tip is provided as input to the processing device, it is well possible to modify the model image data such as to correct for tip shape artefacts. This relates for example to the fact that in a real SPM image, sharp edges are typically not illustrated as sharp edges but as a convolution of the shape of the probe tip and the shape of the edge in the direction of motion of the tip relative to the sample. By performing the various modification suggested above, not only a better fit between the three-dimensional measurement data and the synthetic model image is obtained, but it is also immediately known which shape characteristics relate to the added artefacts, and are no real features of the measured topography. This additional data is obtained as a bonus in the process. In some of these embodiments, the measurement artefact data includes at least one element of a group comprising: noise data for adding noise to the synthetic model image, probe tip shape modification data for correcting the synthetic model image for artefacts in the three-dimensional measurement data caused by a shape of the probe tip, system data for correcting the synthetic model image for system characteristics, such as parameter offsets, measurement limits, measurement ranges or filter effects.

In other or further embodiments, during or subsequent to the step of digitally constructing, the model image data may be adapted such as to match one or more image characteristics of the three-dimensional measurement data, such as number of pixels or pixel size. As may be appreciated, while constructing a synthetic model image, the pixel resolution and/or pixel size may be set at any desired value. However, setting these values to be comparable to the corresponding values of the three-dimensional measurement data performs the sampling correspondingly to the specifics of the measurement. Each pixel in the synthetic model image in that case corresponds to a single measurement point of the probe tip.

In other or further embodiments, the topography of one or more structures comprised by the substrate includes one or more of: an on-surface topography of structures at the surface of the substrate; or a sub-surface topography of structures below the surface of the substrate; or both. As explained earlier, the method is not limited to the application of on-surface topography measurements, but may well be applied to different types of SPM measurements. In some particular embodiments, the topography of one or more structures comprised by the substrate comprises both the on-surface topography and a sub-surface topography, wherein in the synthetic model image the sub-surface topography is projected onto the on-surface topography. This enables the direct combination of on-surface and sub-surface measurements, such as to enable to perform overlay and alignment detection.

In some embodiments, the contour data of the one or more shapes is obtained from at least one of: a shape database, a data file or user input. However, in other or further embodiments, the contour data may be generated by the processor or obtained in a different manner, e.g. from analysis of a designed topography for example. In some other or further embodiments, the shapes may comprise any of a groups comprising: blocks, cubes, spheres, ovoids, solid or hollow cylinders, pyramids (such as triangular pyramids, square pyramids, pentagonal pyramids, hexagonal pyramids, heptagonal pyramids, octagonal pyramids or other polygonal pyramids), bars, cuboids, cones, half-spheres, prisms (such as triangular prisms, square prisms, pentagonal prisms, hexagonal prisms, heptagonal prisms, octagonal prisms or other polygonal prisms), octahedrons, diamonds, star prisms, tetrahedrons, dodecahedrons, ellipsoids, isocahedrons, parallelepipeds, zonohedrons or other three dimensional shapes.

In other or further embodiments, the contour data for each of the one or more shapes are characterized by one or more floating parameters, wherein each floating parameter of a respective shape has a parameter value defining a respective dimension of one or more dimensions of the respective shape; wherein during the step of digitally constructing, the processing device for one or more of said floating parameters sets the parameter value thereof to a starting value; and wherein during the step of iteratively performing the regression operation, the parameter values of the one or more floating parameters are modified for performing the fitting. The selection and tuning of parameter values of floating parameters enables to easily modify the shape characteristics and sizes of the various shapes used for the constructing of the model image data. The regression may be performed using any suitable regression algorithm, for example applying a sum of distances between the measured data and the model image data.

In a further aspect of the invention, there is provided a method of performing scanning probe microscopy on a surface of a substrate using a scanning probe microscopy system, the scanning probe microscopy system comprising a substrate carrier for supporting the substrate, and a probe including a cantilever and a probe tip for scanning the surface of the substrate for obtaining three-dimensional measurement data of a topography of one or more structures comprised by the substrate, wherein the method comprises a processing of the three-dimensional measurement data for providing, at an output, a synthetic model image including three-dimensional topography image data, wherein the processing is performed using a method according to any one or more of the preceding claims. In other or further embodiments, such a method may further include a step of performing metrology measurements on the topography of the one or more structures, wherein the at least a part of the metrology measurements are performed on the synthetic model image.

In yet further aspects, there is provided a scanning probe microscopy system for providing three-dimensional topography image data of one or more structures comprised by a substrate, the scanning probe microscopy system comprising a substrate carrier for supporting the substrate, and a probe including a cantilever and a probe tip for scanning a surface of the substrate for obtaining the three-dimensional measurement data, wherein system further comprises a processing device and a memory suitable for storing instructions which, when executed by the processing device, cause the processing device to carry out at least one of the methods described herein.

In another aspect, there is provided a computer-implemented method of processing three-dimensional measurement data from a scanning probe microscopy system for providing three-dimensional topography image data, the scanning probe microscopy system comprising a substrate carrier for supporting a substrate, and a probe including a cantilever and a probe tip for scanning a surface of the substrate for obtaining the three-dimensional measurement data, wherein the method comprises: receiving, by a processing device of the computer, the three-dimensional measurement data which has been obtained by the scanning probe microscopy system by said scanning of the surface of the substrate, wherein the three-dimensional measurement data maps a topography of one or more structures comprised by the substrate; digitally constructing, by the processing device of the computer, a model image data using shape contour data of one or more shapes, wherein the model image data is constructed by at least one of arranging or sizing of the contour data, such as to match the three-dimensional measurement data for mimicking the topography of the one or more structures comprised by the substrate; iteratively performing, by the processing device of the computer, a regression operation for fitting the model image data to the three-dimensional measurement data, such as to yield from the fitted model image data a synthetic model image of the three-dimensional topography of the substrate; and providing, at an output, the synthetic model image as three-dimensional topography image data of the topography of the substrate, for enabling to perform metrology measurements on the topography of the one or more structures.

In yet a further aspect, there is provided a computer program product comprising instructions which, when the program is executed by a processing device of a computer, cause the processing to carry out any of the methods described above.

### BRIEF DESCRIPTION OF THE DRAWINGS

The invention will further be elucidated by description of some specific embodiments thereof, making reference to the attached drawings. The detailed description provides examples of possible implementations of the invention, but is not to be regarded as describing the only embodiments falling under the scope. The scope of the invention is defined in the claims, and the description is to be regarded as illustrative without being restrictive on the invention. In the drawings:

FIG. 1 schematically illustrates a scanning probe microscopy device in accordance with an embodiment, which may be used in a method of the present invention;

FIG. 2 schematically illustrates a scanning probe microscopy device in accordance with an embodiment, which may be used in a method of the present invention;

FIG. 3 schematically illustrates a three-dimensional image of a substrate surface as well as a representation of a model image obtained with an embodiment of the invention;

FIG. 4A to 4D schematically illustrates the digital construction of model image data in accordance with an embodiment;

FIG. 5 schematically illustrates to a method in accordance with an embodiment of the invention.

### DETAILED DESCRIPTION

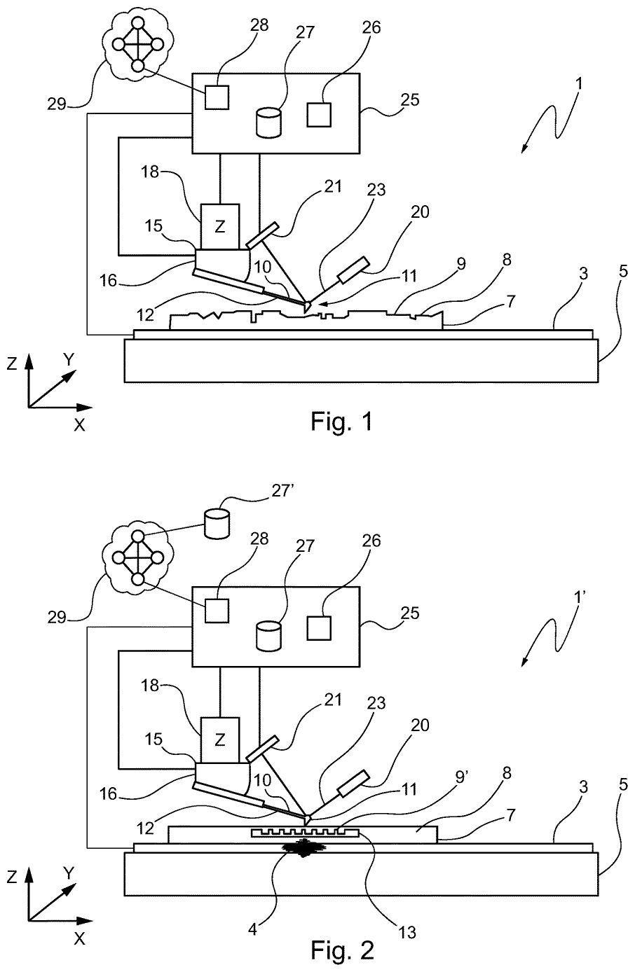

FIGS. 1 and 2 schematically illustrate scanning probe microscopy (SPM) systems 1 and 1′ in accordance with embodiments of the present invention. The systems 1 and 1′ are suitable to be used in a method in accordance with the present invention, by including a processing device 26 and a memory 27 and/or 27′ which are suitable for storing instructions which, when executed by the processing device 26, cause the processing device 26 to carry out a method as described herein, in accordance with one or more embodiments of the invention. The processing device 26 in FIGS. 1 and 2 is illustrated as a single entity in each of the SPM systems 1 and 1′. However, the skilled person may appreciate that although al the described method steps may be implemented by using a single processing device 26, the processing device 26 may be implemented by using multiple elements that together perform the described method steps. The processing device 26 may thus comprise a cluster of multiple processing devices, or may be implemented by various entities which individually perform certain (partial) steps and which cooperatively implement the invention. Furthermore, as illustrated, the memory 27 may be an internal memory 27 or may be an external memory 27′ or another external entity reachable via a data communication network 29. To communicate with data communication network 29, the systems 1 and 1′ may comprise a communication unit 28. In FIGS. 1 and 2, the data storage elements 27, data processing elements 26 and data communication elements 28 are all illustrated as being part of analyzer unit 25 of the systems 1 and 1′. Although this may in many cases be implemented in this manner, this may not always be the case (as already suggested above). The illustration of a single entity 25 in FIGS. 1 and 2 is for the sole purpose of not unnecessarily complicating the figures. In the figures, elements that are technical and functional equivalents, i.e. performing a same or similar function in a same or similar manner with respect to the invention as described herein, may be designated by a same reference numeral or by a same reference numeral followed by a prime (′) or a sub-numbering (“−1”, “−2”, ...) . These entities may be of different nature, for example the memories 27 in FIGS. 1 and 2 may both be internal memories of the systems 1 and 1′, but they may be of a different technical nature or may be implemented (e.g. connected or controlled) in a different manner, while in terms of the invention both providing the function of enabling the storing of data or operation instructions for the processing device 26. Furthermore, the memory 27′ in FIG. 2, has been designated including prime (') in order to indicate that although this element performs (or is able to perform) a function similar or even in certain embodiments identical to the internal memory 27 of system 1′, this memory 27′ (which may even be implemented as a server or as an externally stored data file or data base) is different in the sense that it is not an internal memory but an external memory, without departing from its function in the embodiments of the present invention. The above is just an example, and applies likewise to other entities described below. In principle, unless the contrary is specifically indicated in any part of the present document, it is to be assumed that any entity or element described may be implemented in a different manner in an alternative embodiment.

In the systems 1 and 1′ of FIGS. 1 and 2, a substrate carrier 3 is configured for supporting the substrate or sample 7 to be examined by the SPM system 1, 1′. The substrate carrier 3 is configured, by comprising or being connected to actuators (not shown), for moving the substrate 7 in a plane parallel to the carrier 3. This is typically referred to as the XY-plane of the system. Apart from the ability to move the substrate 7 in the X-and Y-directions, the substrate carrier 3 is connected to a metrology frame 5 which provides a fixed base to the system. The SPM systems 1 and 1′ further include scan heads 15 which are movable in the Z direction. The scan heads 15 each include a chip holder 16 enabling to hold a probe chip comprising a probe 10 forming the sensing element of the SPM system 1 and 1′. The probe 10 includes a cantilever 12 and probe tip 11. The probe tip 11, typically includes a very sharp tip that allows to very accurately (with nanometer accuracy) scan and take measurements at the surface 8 of a substrate 7.

In addition to the above, typically the scan heads 15 further include a sensor system for determining the exact position of the cantilever relative to the scan head. For example, the sensing system in FIGS. 1 and 2 consists of an optical beam deflection (OBD) unit provided by a laser unit 20 for generating an optical beam 23, and a four quadrant optical sensor 21 that receives the reflected beam 23. The beam 23 is directed by the optical system to the backside of the probe tip 11, which includes a specular reflective surface. The specular reflective surface of the probe tip 11 reflects the beam 23 onto the optical detector 21. Any displacement of the probe tip 11 results in the location of impact of the beam 23 on the optical detector 21 to displace as well. In a four quadrant optical detector 21, the light spot formed by beam 23 preferably by default is set to be located exactly in the middle of the four different quadrants of the detector. Therefore, an equal part of the light spot falls on to each quadrant of the four quadrant optical detector 21. It may be appreciated that, even if in practice the laser beam 23 would not exactly be aligned in this manner, the principal of detecting a displacement of the light spot will be the same. All that is needed in order to detect a displacement is that each of the four quadrants of the optical detector 21 receives a fraction of the light from beam 23.

If the probe tip 11 displaces relative to the scan head 15 comprising the laser unit 20, the light spot formed on the optical detector 21 slightly displaces such that the ratio between the different areas illuminated by the light spot on each quadrant of the optical detector 21 changes. From this, the exact position and/or orientation of the probe tip 11 with respect to the scan head 15 can be determined. Because also the Z-position of the probe 10 as applied by the Z-actuator 18 is known (from the control data of the Z-actuator 18), the orientation and location of the probe tip 11 in the Z-direction can be determined. Furthermore, the XY position of the probe tip 11, indicating its position relative to the sample 7 within the plane of the substrate carrier 3, is known from the actuators of the substrate carrier 3. In this manner, in each location of the XY plane, the exact orientation of the probe tip 11 in the Z-direction can be determined in combination with the Z-level applied via the Z-actuator 18.

In the system 1 illustrated in FIG. 1, the above information allows to very accurately determine the exact height of the surface 8 at each point in the XY plane. Therefore, the surface topography 9, consisting of a variety of different structures on the surface 8 of the sample 7, can be accurately determined and mapped such as to provide a topography map. In each point in the XY plane parallel to the sample surface 8, the exact Z-level of the surface 8 can be determined from the data provided for controlling the Z level actuator 18 and the data coming from the optical beam detector optical sensor 21. The data may for example be registered as three-dimensional measurement data in the memory 27 of the system 1. To provide a topography map of the 3D topography of the surface 8, in addition to the above analysis of the data of the Z-level actuator 18 and the optical detector 21, a number of other processing steps have to be performed. These for example include noise reduction and the identification and removal of measurements artifacts.

Similarly, in the SPM system 1′ of FIG. 2, the location and orientation of probe tip 11 is likewise obtained and registered by obtaining measurements with the OBT detector formed by laser unit 20 and optical detector 21 in combination with Z-level data obtained from the actuator control data of Z-level actuator 18. In particular, in the system 1′ of FIG. 2, subsurface measurements are performed of a topography 9′ of a structure 13 that is below the surface 8 of sample 7. To this end, the substrate carrier 3 further includes a vibrational actuator that enables to apply a vibration 4 to the sample 7 from below. In alternative SPM systems, the vibrational signal 4 may be applied in different ways, for example by vibrational actuators on the surface 8 of the sample 7 or on the sides thereof. It is also possible to apply a vibrational signal via the probe 10 using vibrational transducers on the scan head 15, or via the probe tip 11 by periodic power intensity variations in the laser beam 23 provided by a laser unit 20. Such alternative manners of applying a vibrational signal 4 to the sample 7 have been described in literature and are not further discussed here. The present invention may be applied to measurements taken from SPM systems, such as the SPM system 1 performing surface topography measurements or the SPM system 1′ which performs subsurface measurements of topography 9′. The topography 9′ is provided by a subsurface structure 13, which for example may be a preceding layer of a semiconductor element during manufacturing thereof. In this last example, it is typically important to be able to detect whether the overlay of subsequent layers in a semiconductor element is sufficiently accurate to yield a operational semiconductor device, or whether the critical dimensions are as specified having the correct tolerances. Measurement of on-surface and subsurface structures is therefore ideally applied during and after manufacturing of semiconductor devices, for example in an industrial setting. It will be appreciated that during a manufacturing process it is particularly useful to be able to perform such measurements very quickly and very accurately, such that these can be carried out as often as necessary. This eventually increases the yield of operational and correctly functional semiconductor devices and thereby reduces the loss of dysfunctional devices. It is further to be appreciated that in order to perform these measurements accurately at the dimensions of modern semiconductor devices, at least a same level of accuracy is required for performing the imaging. Because optical methods are typically diffraction limited, and the use of scanning electron microscopes (SEM) is often not desired as being potentially destructive, scanning probe microscopy methods provide the best candidates for performing these type of measurements during manufacturing of semiconductor devices.

In the system of FIG. 2, the vibrational acoustic input signal applied via the substrate carrier 3 to the substrate 7 is picked up at the surface 8 of the sample 7 via the probe tip 11. Due to the vibrations, the Z-level of the probe tip 11 is periodically displaced at the frequency applied via the acoustic signal 4. Various of these acoustic measurements techniques are known in the art, amongst which for example the heterodyne methods that use a very high frequency gigahertz acoustic signal including two frequencies in the gigahertz range. The different frequency between two applied frequencies in the gigahertz range is relatively small, typically in the megahertz range. By using the principal of heterodyne mixing of signals, a low frequency signal at the difference frequency (in the megahertz range) can be picked up by the probe tip 11, and can be found by analysis of the output signal obtained via optical beam deflector unit 21. Again, this measurement data needs to be further analyzed in order to obtain therefrom the three dimensional topography data. For example amplitude and phase data may be obtained, and similar to the above, the identification of measurement artifacts and noise reduction is to be performed.

As may be appreciated, both for the SPM system 1 of FIG. 1 and the SPM system 1′ of FIG. 2 (which, by the way, may be integrated into a single SPM system that is able to perform both all surface and subsurface topography measurements), the processing of data in order to obtain a three dimensional image of the topography desired, is relatively complex and requires the processing of a large amount of data obtained from the system. For this reason, conventional SPM systems are relatively slow and may at best be applied to an industrial setting to only a limited extend. The conventional systems are typically too slow in order to perform the desired measurements frequently enough to allow for correction of the manufacturing method or for improvement of the yield of correctly functional semiconductor devices. In the present invention, this is result by the method described herein, which may be implemented using any of the systems for example as illustrated in FIGS. 1 and 2.

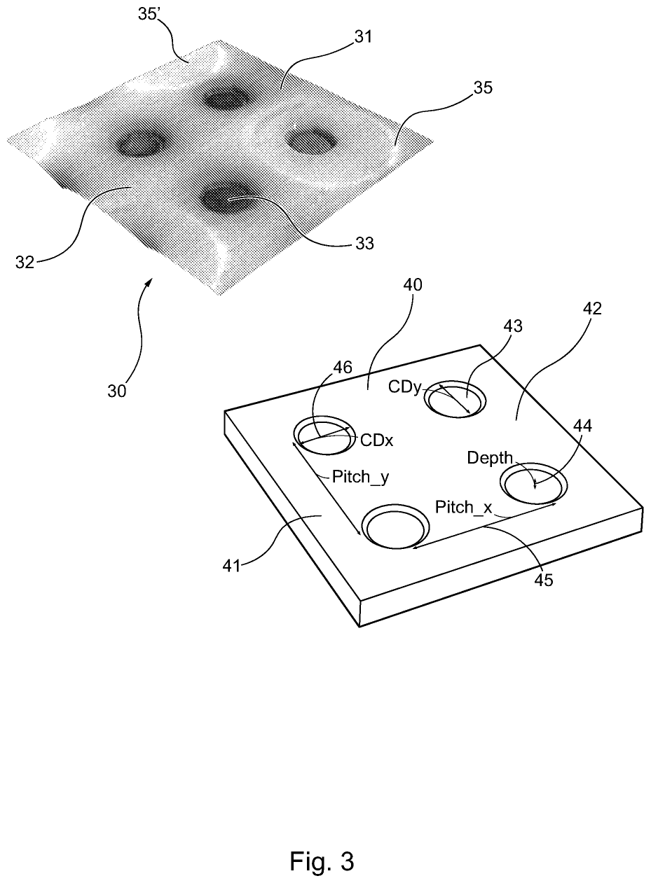

FIG. 3 illustrates an example surface topography image obtained using an SPM system, such as SPM 1. The surface topography image 30 shows an element 31 having a surface 32 including various holes 33 at regular locations. In the lower right corner of FIG. 3, a model image 40 of the element 31 is illustrated that is obtained using a method in accordance with an embodiment of the present the present invention. The model image 40 shows a model structure 41 having a surface 42 with similar holes 43. As follows from FIG. 3, the critical dimensions 46 in XY direction (CDₓ, CD_{y}), the pitch 45 in XY direction (pitch_x, pitch_y), as well as the depth 47 of each hole 43 can be obtained directly from the model structure 41. For an industrial process, wherein a verification of these parameters and their tolerance is desired and wherein it needs to be verified whether for example the overlay of elements is correct, the creation of model images such as model image 40 is sufficient in order to perform this task. The major advantage is that from the rough measurement data that underlies the image 30, it is more easy to construct a model image data 40 using a construction data processing algorithm, than it is to perform all the data processing steps such as to yield the image 30. Furthermore, as follows from looking at the topography image 30, it is less straightforward to obtain accurate measurements of the above mentioned parameters 45, 46 and 47 from the image 30. For example considering the critical dimensions in XY directions 46, as follows from topography image 30, the measurement error in these parameters is larger if these parameter values are determined from topography image 30, in comparison to when parameter values for the same critical dimensions parameters 46 are determined based on model image 40.

On might raise that the model image 40 is not the real data, but a guestimate thereof, and hence the exact parameter values are not known if these are taken from the model image 40. However, the invention is based on the insight that by the digital construction of the model image data, and the subsequent fitting step of this model to the real data, the parameter values determined in this manner more accurately reflect their actual values on the sample 7 than the ones that are determined from topography image 30 directly. This is due to the fact that the fitting steps, performed by regression, converge to a best match of the model image 40 to the topography image 30. In this best match, the differences between the images are minimized not just in one location but everywhere in the image. Thus, by fitting the model image 40 to the topography image 30, the complete three-dimensional measurement data on which the image 30 is based, is used in order to provide a best match. If a parameter value for e.g. the critical dimensions 46 is determined directly from topography image 30, an estimate is typically based on e.g. multiple measurements, but by no means the complete three dimensional measurement data is used. Therefore, the fitting of the model image 40 to the topography image 30, after completion, provides for a very accurate estimate of the parameter values of e.g. the critical dimensions 46.

FIG. 3 in the left upper corner thereof also illustrates exemplary measurements artifacts 35 and 35′. The ring shaped artifact 35, for example, is not one of the actual structures that is present in the topography measured, but comes from preforming the measurement by the SPM. Dependent on the application, it is possible in accordance with some of the embodiments of the present invention to add such artifacts to the image 40 obtained from the construction algorithm. Also, noise can be added deliberately in order to obtain a better match with the original three dimensional measurement data.

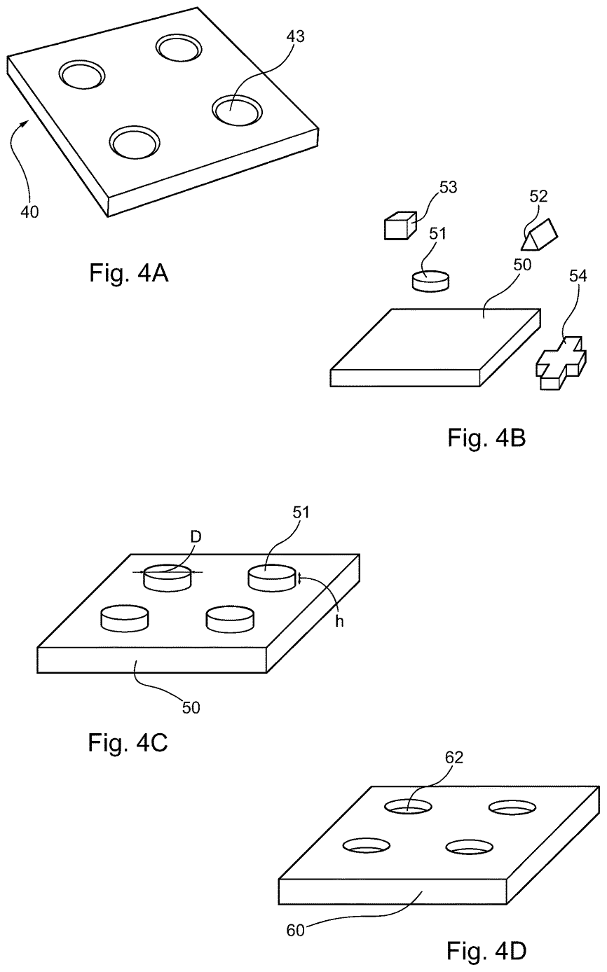

FIGS. 4A through 4D schematically illustrates how the model image 40 is obtained in a digital construction algorithm. FIG. 4A schematically illustrates again the model image 40 which is based on model image data. This model image data, in an embodiment of the present invention, is obtained by constructing shape contour data of one or more known shapes that are present in the database, for example in memory 27. For example, the image 40 of FIG. 4A can be obtained from the various shapes illustrated in FIG. 4D (and many other potential shapes). Each of these shapes can be accurately described by its methodical properties. For example, the base shape 50 is a square plate on the certain thickness. Each of the dimensions of this square plate 50, such as the thickness thereof, but also the width and length, can be provided as floating parameters. Floating parameters are parameters that can be changed during the digital construction algorithm and during the fitting of the model image data later in the process. For example, to obtain the image 40, the starting value or first estimate of the dimensions of the square shaped plate of image 40 may be provided or generated in the system, after which it is improved during the digital construction algorithm and during the fitting later. Other shapes illustrated in FIG. 4B are the disc 51, the prism 52, the cube 53, or the three dimensional cross 54. In fact any three dimensional shape may be used in order to model specific structures or parts thereof, such as to yield the model image data. The examples in FIG. 4B are merely some exemplary three dimensional shapes. In the memory 27 or 27′, the shape contour data of the shapes 50-54 has been stored, including their floating parameters and optionally various other data thereof. In the digital construction step applied in the present invention, the processing device 26, in order to model the structure 31, for example selects the square plate 50 as base shape and may generate starting values for the floating parameters thereof (e.g. reflecting it's typical size). Thereafter, as illustrated in FIG. 4C, the contour data of the disc 51 is obtained, and for each of the holes 43 in the image 40, a shape 51 is subtracted at a particularly defined location of the square shaped plate 50. As for FIG. 4C, the disc 51 may for example include the floating parameters depth or height h and diameter D. Again, the processing device 26 may generate the starting values therefore, in order to subtract the shape from the shape contour data of the square shaped plate 50. To correctly perform the fitting later on, the floating parameters of each shape, as well as their relative positions, may remain floating parameters of the complementary shape of FIGS. 4C and 4D. Eventually in FIG. 4D, the first rough estimate of structure 60 including the holes 62 is shown, forming the model image data to be used as input to the step of fitting.

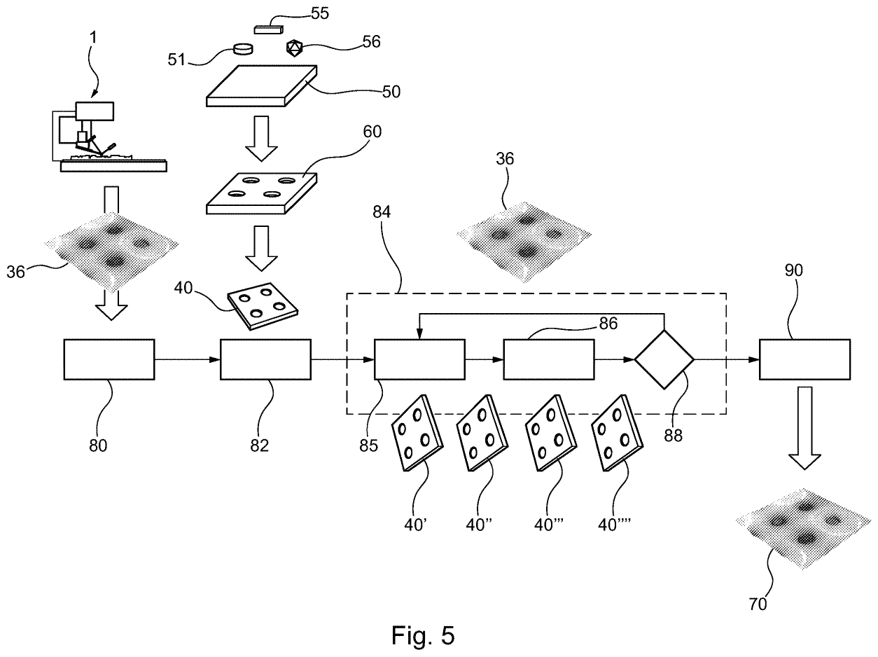

FIG. 5 schematically illustrates the method of the present invention including the implementation of the fitting step thereof. In step 80, three dimensional measurements data 36 is obtained from the SPM system 1. The three dimensional measurement data is obtained by scanning the surface 8 of such shape 7, or for example by taking subsurface measurements of the subsurface structure as described herein before. In step 82, from a memory, a data file, a database or other data repository 27 or 27′, shape contour data of a plurality of shapes is obtained. Using these, the digital construction algorithm illustrated in FIG. 4 is performed to yield model image data 60, by suitably combining and shaping the shape contour data. For example some of the shapes 50-56 may be added to, or subtracted from other shapes 50-56 in order to obtain any arbitrary complementary shape 60. Shapes may be moved relative to each other, rotated in various directions, truncated suitably, enlarged, compressed, skewed, twisted or any other suitable operation in order to digitally construct the desired model image. This eventually yields the model image data 40 which is provided as input to step 85. In step 85, the model image data 40 is compared to the three dimensional measurement data 36 obtained from system 1. As may be appreciated, in order to enable the comparison, the model image data is used in order to generate a modelled topography data in a similar resolution as the three dimensional measurement data 36. The comparing in step 85 may take place by obtaining the difference between the two data files, after which by proper reshaping and fitting in step 86, the differences between the model image data 40 and the three dimensional measurement data 36 are reduced.

For example in step 85, both the three dimensional measurement data 36 and the model image data 40 are received by the processing system, and in step 86 the model image data 40, in particular the floating parameters thereof, are modified to obtain a better match between the model image data 40 and the three dimensional measurement data 36. In 86, the model image data may for example be rotated, stretched, enlarged, diminished, translated, displaced, in order to obtain a better fit, or even the particular individual floating parameters may be slightly amended to obtain the correct fit. To do so, a conventional regression algorithm may be applied, but it is also possible to train a self-learning data processing model (AI-model) to do this job. In step 88, it is determined whether the processing in step 86 has improved or worsened the match between the three dimensional image data 36 and model image data 40. The algorithm in the fitting step 84 continues until the differences are sufficiently small, or until a minimum of the differences between the model image data 40 and the three dimensional measurement data 36 is obtained (e.g. is after subsequent steps, the differences do not become smaller). Then, the model image data is provided as a synthetic model image 70 of the three dimensional topography of the substrate 7 at the output 90 of the method. The synthetic model image 70, bears a lot of information on the modelled structure. For example each of the floating parameters have now been defined, and the critical dimensions or the pitch between the holes 43 can be exactly determined also, if it is exactly known which part of the image relate to measurement artifacts, and how large this effect is. The noise in the image can be conveniently removed by turning it ‘on’ or ‘off’, and the synthetic model image 70 of the surface topography of the sample 7 therefore allows to very effectively perform the determination and monitoring of the manufacturing parameters and the overlay during manufacturing of a semiconductor device.

Terminology used for describing particular embodiments is not intended to be limiting of the invention. As used herein, the singular forms “a”, “an” and “the” are intended to include the plural forms as well, unless the context clearly indicates otherwise. The term “and/or” includes any and all combinations of one or more of the associated listed items. It will be understood that the terms “comprises” and/or “comprising” specify the presence of stated features but do not preclude the presence or addition of one or more other features. It will be further understood that when a particular step of a method is referred to as subsequent to another step, it can directly follow said other step or one or more intermediate steps may be carried out before carrying out the particular step, unless specified otherwise. Likewise it will be understood that when a connection between structures or components is described, this connection may be established directly or through intermediate structures or components unless specified otherwise.

The invention is described more fully hereinafter with reference to the accompanying drawings, in which embodiments of the invention are shown. In the drawings, the absolute and relative sizes of systems, components, layers, and regions may be exaggerated for clarity. Embodiments may be described with reference to schematic and/or cross-section illustrations of possibly idealized embodiments and intermediate structures of the invention. In the description and drawings, like numbers refer to like elements throughout. Relative terms as well as derivatives thereof should be construed to refer to the orientation as then described or as shown in the drawing under discussion. These relative terms are for convenience of description and do not require that the system be constructed or operated in a particular orientation unless stated otherwise.

The present invention has been described in terms of some specific embodiments thereof. It will be appreciated that the embodiments shown in the drawings and described herein are intended for illustrated purposes only and are not by any manner or means intended to be restrictive on the invention. It is believed that the operation and construction of the present invention will be apparent from the foregoing description and drawings appended thereto. It will be clear to the skilled person that the invention is not limited to any embodiment herein described and that modifications are possible which should be considered within the scope of the appended claims. Also kinematic inversions are considered inherently disclosed and to be within the scope of the invention. Moreover, any of the components and elements of the various embodiments disclosed may be combined or may be incorporated in other embodiments where considered necessary, desired or preferred, without departing from the scope of the invention as defined in the claims.

In the claims, any reference signs shall not be construed as limiting the claim. The term ‘comprising’ and ‘including’ when used in this description or the appended claims should not be construed in an exclusive or exhaustive sense but rather in an inclusive sense. Thus the expression ‘comprising’ as used herein does not exclude the presence of other elements or steps in addition to those listed in any claim. Expressions such as “consisting of”, when used in this description or the appended claims, should be construed not as an exhaustive enumeration but rather in an inclusive sense of “at least consisting of”. Furthermore, the words ‘a’ and ‘an’ shall not be construed as limited to ‘only one’, but instead are used to mean ‘at least one’, and do not exclude a plurality. Features that are not specifically or explicitly described or claimed may be additionally included in the structure of the invention within its scope. Any of the claimed or disclosed devices or portions thereof may be combined together or separated into further portions unless specifically stated otherwise, without departing from the claimed invention. Expressions such as: “means for ...” should be read as: “component configured for ...” or “member constructed to ...” and should be construed to include equivalents for the structures disclosed. The use of expressions like: “critical”, “preferred”, “especially preferred” etc. is not intended to limit the invention. Additions, deletions, and modifications within the purview of the skilled person may generally be made without departing from the spirit and scope of the invention, as is determined by the claims. The invention may be practiced otherwise then as specifically described herein, and is only limited by the appended claims.

1. A method of processing three-dimensional measurement data from a scanning probe microscopy system for providing three-dimensional topography image data the scanning probe microscopy system comprising a substrate carrier for supporting a substrate and a probe including a cantilever and a probe tip for scanning a surface of the substrate for obtaining the three-dimensional measurement data, wherein the method comprises:
receiving, by a processing device the three-dimensional measurement data which has been obtained by the scanning probe microscopy system by said scanning of the surface of the substrate, wherein the three-dimensional measurement data maps a topography of one or more structures comprised by the substrate;
digitally constructing, by the processing device, a model image data from building blocks, wherein the building blocks are provided by shapes, wherein each shape is digitally defined by shape contour data, wherein the model image data is constructed by at least one of arranging or sizing of the shape contour data, such as to match the three-dimensional measurement data for mimicking the topography of the one or more structures comprised by the substrate;
iteratively performing, by the processing device, a regression operation for fitting the model image data to the three-dimensional measurement data, such as to yield from the fitted model image data a synthetic model image of the three-dimensional topography of the substrate; and
providing, at an output, the synthetic model image as three-dimensional topography image data of the topography of the substrate, for enabling to perform metrology measurements on the topography of the one or more structures.

2. The method according to claim 1, wherein said arranging or sizing of the shape contour data comprises at least one of: translating, rotating, inflating, deflating, flattening, stretching, compacting, truncating or resizing of the shape contour data of the one or more shapes; or the combining, merging, uniting or subtracting of shape contour data of at least two of the shapes.

3. The method according to claim 1, wherein the shape contour data of the one or more shapes is obtained from at least one of: a shape database, a data file or user input.

4. The method according to claim 1, wherein the method further comprises a step of adapting the model image data such as to include therein measurement artefact data, wherein the measurement artefact data is indicative of image modifications caused by the obtaining of the three-dimensional measurement data by the scanning probe microscopy system.

5. The method according to claim 4, wherein the measurement artefact data includes at least one element of a group comprising: noise data for adding noise to the synthetic model image, probe tip shape modification data for correcting the synthetic model image for artefacts in the three-dimensional measurement data caused by a shape of the probe tip, system data for correcting the synthetic model image for system characteristics.

6. The method according to claim 1, wherein during or subsequent to the step of digitally constructing, the model image data is adapted such as to match one or more image characteristics of the three-dimensional measurement data.

7. The method according to claim 1, wherein the topography of one or more structures comprised by the substrate includes one or more of: an on-surface topography of structures at the surface of the substrate; or a sub-surface topography of structures below the surface of the substrate or both.

8. The method according to claim 7, wherein the topography of one or more structures comprised by the substrate comprises both the on-surface topography and a sub-surface topography, wherein in the synthetic model image the sub-surface topography is projected onto the on-surface topography.

9. The method according to claim 1, wherein the one or more shapes are elements selected from a group comprising: blocks; cubes; spheres; ovoids; solid or hollow cylinders; pyramids: bars; cuboids; cones; half-spheres; octahedrons; diamonds; star prisms; tetrahedrons; dodecahedrons; ellipsoids; isocahedrons; parallelepipeds; zonohedrons or other three dimensional shapes.

10. The method according to claim 1, wherein the shape contour data for each of the one or more shapes are characterized by one or more floating parameters, wherein each floating parameter of a respective shape has a parameter value defining a respective dimension of one or more dimensions of the respective shape; wherein during the step of digitally constructing, the processing device for one or more of said floating parameters sets the parameter value thereof to a starting value; and wherein during the step of iteratively performing the regression operation, the parameter values of the one or more floating parameters are modified for performing the fitting.

11. A method of performing scanning probe microscopy on a surface of a substrate using a scanning probe microscopy system, the scanning probe microscopy system comprising a substrate carrier for supporting the substrate, and a probe including a cantilever and a probe tip for scanning the surface of the substrate for obtaining three-dimensional measurement data of a topography of one or more structures comprised by the substrate, wherein the method comprises a processing of the three-dimensional measurement data for providing, at an output, a synthetic model image including three-dimensional topography image data, wherein the processing is performed using the method according to claim 1.

12. The method according to claim 11, further including a step of performing metrology measurements on the topography of the one or more structures, wherein the at least a part of the metrology measurements are performed on the synthetic model image.

13. A scanning probe microscopy system for providing three-dimensional topography image data of one or more structures comprised by a substrate, the scanning probe microscopy system comprising a substrate carrier for supporting the substrate and a probe including a cantilever and a probe tip for scanning a surface of the substrate for obtaining the three-dimensional measurement data, wherein system further comprises a processing device and a memory suitable for storing instructions which, when executed by the processing device, cause the processing device to carry out at least one of the method of claim 1.

14. A computer-implemented method of processing three-dimensional measurement data from a scanning probe microscopy system for providing three-dimensional topography image data, the scanning probe microscopy system comprising a substrate carrier for supporting a substrate, and a probe including a cantilever and a probe tip for scanning a surface of the substrate for obtaining the three-dimensional measurement data, wherein the method comprises:
receiving, by a processing device of the computer, the three-dimensional measurement data which has been obtained by the scanning probe microscopy system by said scanning of the surface of the substrate, wherein the three-dimensional measurement data maps a topography of one or more structures comprised by the substrate;
digitally constructing, by the processing device of the computer, a model image data from building blocks, wherein the building blocks are provided by shapes, wherein each shape is digitally defined by shape contour data, wherein the model image data is constructed by at least one of arranging or sizing of the shape contour data, such as to match the three-dimensional measurement data for mimicking the topography of the one or more structures comprised by the substrate;
iteratively performing, by the processing device of the computer, a regression operation for fitting the model image data to the three-dimensional measurement data, such as to yield from the fitted model image data a synthetic model image of the three-dimensional topography of the substrate; and
providing, at an output, the synthetic model image as three-dimensional topography image data of the topography of the substrate, for enabling to perform metrology measurements on the topography of the one or more structures.

15. A non-transitory computer-program readable medium comprising instructions which, when executed by a processor, cause the processor to perform the method of claim 1.

16. The method of claim 5, wherein the system characteristics are parameter offsets, measurement limits, measurement ranges, or filter effects.

17. The method of claim 6, wherein the one or more image characteristics of the three-dimensional measurement data are number of pixels or pixel size.

18. The method according to claim 9, wherein the one or more shapes are pyramids, and the pyramids are triangular pyramids, square pyramids, pentagonal pyramids, hexagonal pyramids, heptagonal pyramids, octagonal pyramids or other polygonal pyramids.

19. The method according to claim 9, wherein the one or more shapes are prisms, and the prisms are triangular prisms, square prisms, pentagonal prisms, hexagonal prisms, heptagonal prisms, octagonal prisms or other polygonal prisms.

20. A non-transitory computer readable medium comprising instructions which, when executed by a processor, cause the processor to perform the method of claim 11.
